(19) United States
(12) Patent Application Publication
(10) Pub. No.: US 2013/0268783 A1
(43) Pub. Date: Oct. 10, 2013

(54) System and Method for Using Energy Efficiency Network Refresh Signals for Exchanging Link Partner and Device Information

(71) Applicant: BROADCOM CORPORATION, Irvine, CA (US)

(72) Inventors: Wael William Diab, San Francisco, CA (US); Velu Pillai, Austin, TX (US)

(73) Assignee: Broadcom Corporation, Irvine, CA (US)

(21) Appl. No.: 13/628,120

(22) Filed: Sep. 27, 2012

Related U.S. Application Data
(60) Provisional application No. 61/620,212, filed on Apr. 4, 2012.

(51) Int. Cl. G06F 1/32

(52) U.S. Cl. 713/310

(57) ABSTRACT

A system and method for using energy efficiency network refresh signals for exchanging link partner and device information. Energy savings can be realized through a usage of a energy saving state such as a low power idle (LPI) mode. In one embodiment, refresh signals used during the LPI mode can be used to encode information or state within the refresh signals. In general, such encoded information enables link partners to exchange information that would otherwise need to wait until the link partners have transitioned from an energy saving state back to the active state. In various examples, the messaging during the energy saving state can be used to facilitate synchronization during the energy saving state, transitions from the energy saving state, etc.

This application claims priority to provisional patent application No. 61/620,212, filed Apr. 4, 2012, which is incorporated by reference herein, in its entirety, for all purposes.

### BACKGROUND

1. Field of the Invention

The present invention relates generally to networking and, more particularly, to a system and method for using energy efficiency network refresh signals for exchanging link partner and device information.

2. Introduction

Energy costs continue to escalate in a trend that has accelerated in recent years. Such being the case, various industries have become increasingly sensitive to the impact of those rising costs. One area that has drawn increasing scrutiny is the IT infrastructure. Many companies are now looking at their IT systems' power usage to determine whether the energy costs can be reduced. For this reason, an industry focus on energy efficient networks (IEEE 802.3az) has arisen to address the rising costs of IT equipment usage as a whole (i.e., PCs, displays, printers, switches, servers, network equipment, etc.).

In designing an energy efficient solution, one of the considerations is network link utilization. For example, many network links are typically in an idle state between sporadic bursts of data traffic. An additional consideration for an energy efficient solution is the extent to which the traffic is sensitive to buffering and latency. For example, some traffic patterns (e.g., HPC cluster or high-end 24-hr data center) are very sensitive to latency such that buffering would be problematic.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an Ethernet link between link partners.

FIG. 2 illustrates coded refresh signals during a low power idle mode.

FIG. 3 illustrates a flowchart of a process of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Energy efficient networks attempt to save power when the traffic utilization of the network is not at its maximum capacity. This serves to minimize the performance impact while maximizing energy savings. In one example, energy savings can be realized through a usage of a energy saving state such as a low power idle (LPI) mode. In accordance with the present invention, refresh signals used during the LPI mode to facilitate synchronization (e.g., frequency/phase lock) and filter/equalization adaptation can be used to encode information or state within the refresh signals. In general, such encoded information enables link partners to exchange information that would otherwise need to wait until the link partners have transitioned from an energy saving state back to the active state. In various examples, the messaging during the energy saving state can be used to facilitate synchronization during the energy saving state, transitions from the energy saving state, etc.

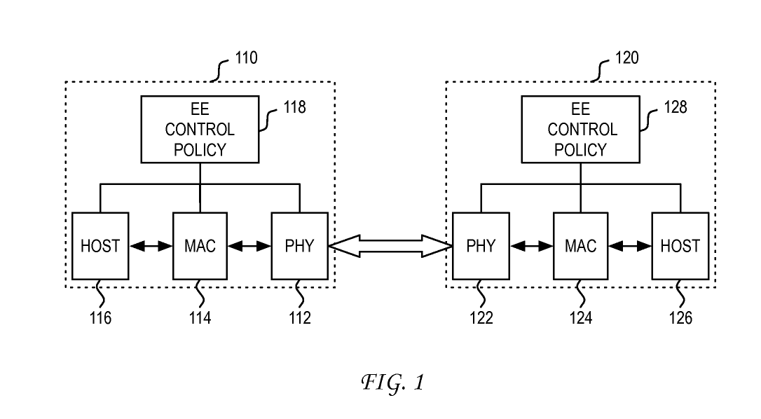

FIG. 1 illustrates an example link that can enable energy savings. As illustrated, the link supports communication between a first link partner 110 and a second link partner 120. In various embodiments, link partners 110 and 120 can represent a switch, router, endpoint (e.g., server, client, VOIP phone, wireless access point, etc.), or the like. As illustrated, link partner 110 includes physical layer device (PHY) 112, media access control (MAC) 114, and host 116, while link partner 120 includes PHY 122, MAC 124, and host 126.

In general, hosts 116 and 126 may comprise suitable logic, circuitry, and/or code that may enable operability and/or functionality of the five highest functional layers for data packets that are to be transmitted over the link. Since each layer in the OSI model provides a service to the immediately higher interfacing layer, MAC controllers 114 and 124 may provide the necessary services to hosts 116 and 126 to ensure that packets are suitably formatted and communicated to PHYs 112 and 122, respectively. MAC controllers 114 and 124 may comprise suitable logic, circuitry, and/or code that may enable handling of data link layer (Layer 2) operability and/or functionality. MAC controllers 114 and 124 can be configured to implement Ethernet protocols, such as those based on the IEEE 802.3 standard, for example. PHYs 112 and 122 can be configured to handle physical layer requirements, which include, but are not limited to, packetization, data transfer and serialization/deserialization (SERDES).

As FIG. 1 further illustrates, link partners 110 and 120 also include energy efficiency control policy entities 118 and 128, respectively. In general, energy efficiency control policy entities 118 and 128 can be designed to determine when to enter an energy saving state, what energy saving state (i.e., level of energy savings) to enter, how long to remain in that energy saving state, what energy saving state to transition to out of the previous energy saving state, etc. In one embodiment, energy efficiency control policies can base these energy-saving decisions on a combination of settings established by an IT manager and the properties of the traffic on the link itself

In general, energy efficiency control policy entities 118 and 128 can comprise suitable logic, circuitry, and/or code that may be enabled to establish and/or implement an energy efficiency control policy for the network device. In various embodiments, energy efficiency control policy entities 118 and 128 can be a logical and/or functional block which may, for example, be implemented in one or more layers, including portions of the PHY or enhanced PHY, MAC, switch, controller, or other subsystems in the host, thereby enabling energy-efficiency control at one or more layers.

In one example, energy efficient Ethernet such as that defined by IEEE 802.3az can provide substantial energy savings through the use of a LPI mode. In general, the LPI mode can be entered when a transmitter enters a period of silence when there is no data to be sent.

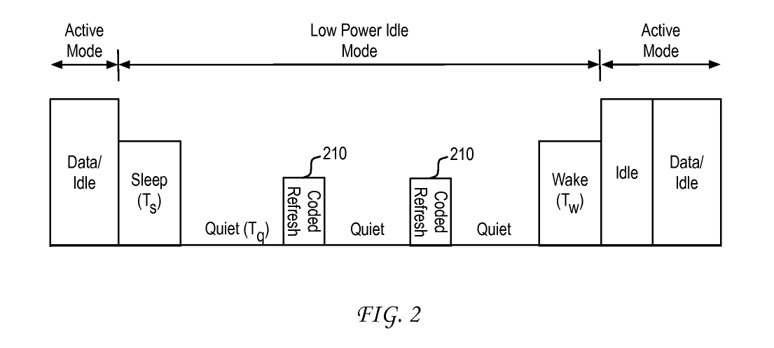

FIG. 2 illustrates the transitions between an active mode and a LPI mode. As illustrated, a transmitter can begin in an active mode where data traffic and normal idle signals are transmitted. When it is determined by an energy efficiency control policy that the absence of data traffic indicates a sufficiently low link utilization condition, the energy efficiency control policy can then instruct the transmitter to enter into a LPI mode. A transition from an active mode to the LPI mode takes a sleep time Tₛ, after which time the transmitter can enter a quiet state. The transmitter can stay quiet for a time T_{q}, after which the transmitter will transmit a refresh signal.

In general, refresh signals are sent periodically to keep the link alive and to enable the receiver to maintain facilitate synchronization (e.g., frequency/phase lock) and filter/equalization adaptation. This enables the link partners to minimize the amount of time that it takes to transition from the LPI mode back to an active mode for the continued exchange of data traffic.

As the transmitter can remain in the quiet state until data traffic is ready to be transmitted, significant energy savings can be achieved. When there is data to transmit, a normal idle signal can be used to wake the transmit system up before the data traffic can be sent. As illustrated, the transmitter can take a time T_{w} to wake up and re-enter the active state once again for transmission of data traffic that is available.

As illustrated in FIG. 2, the refresh signals 210 are coded refresh signals. In addition to their usage to facilitate synchronization and filter/equalization adaptation, coded refresh signals 210 are designed to encode information or state within the refresh signals. This encoded information or state within the refresh signals can be used in a variety of ways.

In various examples, the encoded refresh signals can include information to better re-align the synchronization between link partners, can exchange state (e.g., pre-wake information) to allow a dynamic switch over from a slow wake process (e.g., wake up in 15 ms) to a faster wake process (e.g., wake up in 5 ms), thereby obviating the need to re-negotiate the link via autonegotiation or another slower mechanism like LLDP, can exchange information (e.g., signal of state transition to deeper sleep state) between the link partners that would otherwise be required to wake up the link by transitioning from the quiet state to the active state, can exchange information to configure an energy efficiency control policy, or the like.

As would be appreciated, the principles of the present invention are not limited to particular examples of use cases of coded refresh signals. In general, the encoding of information or state in the refresh signals enables communication during the quiet state, which can enable greater energy savings by enabling the system to maintain the quiet state without having to transition back to the active state for the transmission of message information between the link partners.

The particular mechanism used to encode refresh signals would be implementation dependent. This encoding can be designed to communicate bit(s), symbol(s), mini-packet(s), or the like. As would be appreciated, the particular type of encoding used for the refresh signals can also influence the portions of the receiver that remain active while in the quiet state. In one embodiment, a coded refresh signaling protocol can be used to enable the activation of portions of the receiver that are used to decode the coded refresh signals.

In one example, the coded refresh signal can be based on different forms of refresh idle characters. In this example, the different forms of refresh idle characters can be sequenced in a way to transmit encoded information. For instance, two distinct refresh idle characters can be used transmit a sequence of bits. In another example, non-idle characters can be substituted for idle characters to transmit information or state. Here, it should be noted that where the information represented by the refresh signal can be distinguishable on its own, a single coded refresh signal can be used to communicate information or state rather than multiple coded refresh signals.

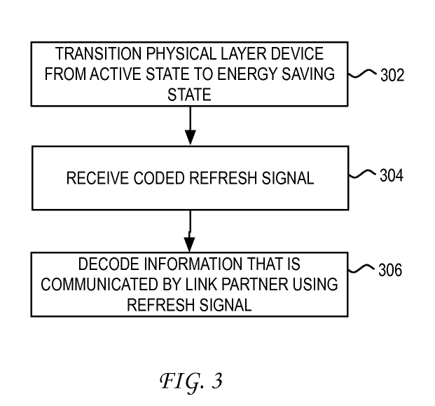

To further illustrate the features of the present invention, reference is now made to the flowchart of FIG. 3. As illustrated, the process begins at step 302 where a physical layer device is transitioned from an active state to an energy saving state such as low power idle. As would be appreciated, the particular trigger for such a transition would be implementation dependent. In general, such a transition is designed to generate energy savings when a link utilization is sufficiently low to warrant a transition to the energy saving state.

While in the energy saving state, the physical layer device can receive one or more coded refresh signals. In general, the transmission of such coded refresh signals enables the physical layer device to facilitate synchronization and filter/equalization adaptation with its link partner. This synchronization and filter/equalization adaptation enables the physical layer device to quickly transition back to the active state.

In addition to the use of refresh signals in a synchronization and filter/equalization adaptation process, the physical layer device can also decode, at step 306, the information that is communicated by the link partner using the refresh signal. Here, it should be noted that the information can be decoded from a single refresh signal or a sequence of a plurality of refresh signals. Regardless of the number of refresh signals needed to communicate the information, the coded refresh signal(s) enables information to be communicated while in the energy saving state. A transition by the physical layer device back to the active state is therefore unneeded to accommodate the communication of such information. Energy savings are therefore maximized.

The particular type of information communicated using coded refresh signals can vary. In one example, the coded information can be used to configure, support or otherwise influence the operation of the energy savings initiatives implemented by the energy efficiency control policy while in an energy saving state. As noted above, such coded information can be used to effect state transitions (e.g., from a sleep state to a deeper sleep state, selection of a particular type of wake-up process, etc.).

It should be noted that the principles of the present invention outlined above can be applied to various savings contexts. For example, the principles of the present invention can be used with different PHY types (e.g., twisted pair, backplane, optical) and different standard or non-standard network speeds (e.g., 1 G, 2.5 G, 10 G, 40 G, 100 G, 400 G, 1 T, etc.). Any data transmission link that can be designed to implement a LPI mode can benefit from the increased energy savings afforded by the usage of refresh signals to transmit encoded information.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method, comprising:
transitioning a physical layer device from an active state to an energy saving state upon an identification of a low link utilization condition;
receiving, by said physical layer device, a coded refresh signal;
adapting filter coefficients of said physical layer device using said received coded refresh signal; and
decoding information that is contained in said coded refresh signal; and
configuring, while said physical layer device remains in said energy saving state, an energy efficiency control policy based on said decoded information, said energy efficiency control policy governing transitions between energy saving states in said physical layer device.

2. The method of claim 1, wherein said transitioning comprises transitioning said physical layer device from an active state to a low power idle state.

3. The method of claim 1, wherein said configuring comprises configuring said energy efficiency control policy based on decoded information from a single coded refresh signal.

4. The method of claim 1, wherein said configuring comprises configuring said energy efficiency control policy based on decoded information from a plurality of coded refresh signals.

5. The method of claim 1, wherein said configuring comprises adjusting a wake up process of said physical layer device.

6. A method, comprising:
after transitioning a physical layer device from an active state to an energy saving state upon an identification of a low utilization condition of a link that connects said physical layer device to a link partner device, receiving, by said physical layer device, a coded refresh signal that enables said physical layer device to maintain synchronization with said link partner while said physical layer device remains in said energy saving state; and
modifying, while said physical layer device remains in said energy saving state, an energy efficiency control policy based on information that is contained in said received coded refresh signal.

7. The method of claim 6, wherein said energy saving state is a low power idle state.

8. The method of claim 6, wherein said modifying comprises modifying said energy efficiency control policy based on decoded information from a single coded refresh signal.

9. The method of claim 6, wherein said modifying comprises modifying said energy efficiency control policy based on decoded information from a plurality of coded refresh signals.

10. The method of claim 6, wherein said modifying comprises modifying a wake up process of said physical layer device.

11. A physical layer device, comprising:
a controller that transitions said physical layer device in a first link partner device from an active state to an energy saving state upon an identification of a low utilization condition of a link that connects said first link partner device to a second link partner device; and
a transmitter that transmits, while said physical layer device remains in said energy saving state, a plurality of refresh signals periodically in accordance with a defined refresh time period, said plurality of refresh signals being used for synchronization of said first link partner device and said second link partner device, wherein at least one of said plurality of refresh signals has information encoded therein that enables a modification of an energy efficiency control policy in said second link partner device while said physical layer device remains in said energy saving state.

12. The physical layer device of claim 11, wherein said energy saving state is a low power idle state.

13. The physical layer device of claim 11, wherein said encoded information is used to signal to said second link partner device a type of wake up process for use in transitioning from said energy saving state to said active state.

14. The physical layer device of claim 11, wherein said encoded information is used to signal state information to said second link partner device.

15. The physical layer device of claim 11, wherein one of said plurality of refresh signals is used to communicate a message from said first link partner device to said second link partner device.

16. The physical layer device of claim 11, wherein two or more of said plurality of refresh signals is used to communicate a message from said first link partner device to said second link partner device.
